(19) United States
(12) Patent Application Publication
(10) Pub. No.: US 2023/0100088 A1
(43) Pub. Date: Mar. 30, 2023

(54) APPARATUS FOR SEPARATING FEATURE POINTS FOR EACH OBJECT, METHOD FOR SEPARATING FEATURE POINTS FOR EACH OBJECT AND COMPUTER PROGRAM

(71) Applicant: NIPPON TELEGRAPH AND TELEPHONE CORPORATION, Tokyo (JP)

(72) Inventors: Masaaki MATSUMURA, Musashino-shi, Tokyo (JP); Hajime NOTO, Musashino-shi, Tokyo (JP); Yoshinori KUSACHI, Musashino-shi, Tokyo (JP)

(73) Assignee: NIPPON TELEGRAPH AND TELEPHONE CORPORATION, Tokyo (JP)

(21) Appl. No.: 17/800,478

(22) PCT Filed: Feb. 20, 2020
(86) PCT No.: PCT/JP2020/006882

§ 371 Date: Aug. 17, 2022

(51) Int. Cl. G06V 10/77; G06V 10/774; G06T 7/73

(52) U.S. Cl. CPC G06V 10/7715; G06V 10/774; G06T 7/74; G06T 2207/30196

(57) ABSTRACT

An object-specific keypoint separation apparatus includes: an inference execution unit configured to receive a captured image capturing an object as an input and use a pre-trained model that has been trained in order to output a plurality of first maps and a plurality of second maps generated from the input captured image to output the plurality of first maps and the plurality of second maps, the plurality of first maps storing, for keypoints of the object. a distance from a first keypoint only around a second keypoint, and the plurality of second maps representing a heat map configured to have a peak at coordinates at which the keypoint of the object appears; and an object-specific keypoint separation unit configured to separate the keypoints for each object based on the plurality of first maps and the plurality of second maps output from the inference execution unit.

### TECHNICAL FIELD

The present invention relates to an object-specific keypoint separation apparatus, an object-specific keypoint separation method, and a computer program.

### BACKGROUND ART

Techniques for estimating two-dimensional coordinates of keypoints such as joints, eyes, ears, and the nose of an object in an image captured by an imaging device such as a digital camera or a video camera for each object in the image and separating the keypoints for each object have been proposed. Machine learning using deep learning has been widely applied in such technical fields. For example, a known technique of separating keypoints for each object uses a pre-trained model for training heat maps each configured to have a peak at the coordinates at which each keypoint appears in the image and vector fields each describing the connection relationship of respective keypoints. Hereinafter, separating keypoints for each object will be referred to as object-specific keypoint separation.

Keypoints of an object are described in a tree-like hierarchical structure as illustrated in FIG. 6. FIG. 6 is a diagram illustrating exemplary keypoints defined in the Microsoft Common Object in Context (MS COCO) dataset. Training is performed for vector fields each describing the connection relationship of respective keypoints to generate a vector in the direction from a child keypoint to a parent keypoint in a hierarchical structure. A keypoint 110 is a keypoint representing the position of the nose. A keypoint 111 is a keypoint representing the position of the left eye. A keypoint 112 is a keypoint representing the position of the right eye. Keypoints 113 to 126 are keypoints representing the positions of other parts defined for the object.

NPL 1 has proposed a technique to perform object-specific keypoint separation at a high speed in which vector fields describing the connection relationships of keypoints that are called part affinity fields are trained, and certainties of the connection relationships between the keypoints are calculated using a line integral of the vector fields.

NPL 2 has proposed a technique to increase accuracy in object-specific keypoint separation by using three vector fields and a mask. Specifically in NPL 2, first, a person segmentation mask, which masks object regions in an image in a silhouette shape, is generated in addition to three vector fields including short-range offsets, mid-range offsets, and long-range offsets. In NPL 2, next, the two vector fields of the short-range offsets and mid-range offsets are used to generate connection relationships of keypoints. Then, in NPL 2, the image is divided into regions corresponding to the number of persons who are objects using the short-range offsets, the long-range offsets, and the person segmentation mask. As a result, accuracy in object-specific keypoint separation is enhanced according to NPL 2. Further, in NPL 2, the vector field describing the connection relationship between parent and child keypoints is only mid-range offsets. The short-range offsets are a vector field for correction in which each keypoint is described to face the center. The long-range offsets are a vector field describing that the region surrounded by the person segmentation mask points to the coordinates of the nose of the object.

### CITATION LIST

### Non Patent Literature

NPL 1: Cao, Z., Hidalgo, G., Simon, T., Wei, S. E., Sheikh, Y., “OpenPose: Realtime Multi-Person 2D Pose Estimation using Part Affinity Fields”, in arXiv preprint arXiv: 1812.08008, 2018.
NPL 2: G. Papandreou, T. Zhu, L.-C. Chen, S. Gidaris, J. Tompson, and K. Murphy, “PersonLab: Person Pose Estimation and Instance Segmentation with a Bottom-Up, Part-Based, Geometric Embedding Model”, in arXiv: 1803.08225, 2018.

### SUMMARY OF THE INVENTION

### Technical Problem

In the related art, a plurality of vector fields are used to describe a connection relationship between keypoints and to separate keypoints for each of objects. Thus, two matrices that represent the directions of the x- and y-axes are required for describing vector fields. As a result, a large amount of memory is required because data in the amount of the output resolution of the vector fields×the number of vector fields×2 (the number of matrices describing the vector fields) needs to be handled. Particularly during machine learning using deep learning, it is difficult to perform training of complex networks because it requires a more amount of memory than prediction does.

For example, a vector field of mid-range offsets is configured as illustrated in FIG. 7 according to NPL 2. FIG. 7 is a diagram illustrating exemplary matrices of a vector field in a technique of the related art. In the technique of the related art, the amount of data to be handled is large, which requires a large amount of memory capacity, as illustrated in FIG. 7.

In view of the above circumstances, the present invention aims to provide a technique that enables a memory capacity used for object-specific keypoint separation to be reduced.

### Means for Solving the Problem

According to an aspect of the present invention, an object-specific keypoint separation apparatus includes: an inference execution unit configured to receive a captured image capturing an object as an input and use a pre-trained model that has been trained in order to output a plurality of first maps and a plurality of second maps generated from the input captured image to output the plurality of first maps and the plurality of second maps, the plurality of first maps storing a distance from a first keypoint of the object only around a second keypoint, and the plurality of second maps representing a heat map configured to have a peak at coordinates at which the keypoint of the object appears; and an object-specific keypoint separation unit configured to separate the keypoints for each object based on the plurality of first maps and the plurality of second maps output from the inference execution unit.

According to an aspect of the present invention, an object-specific keypoint separation method includes: receiving a captured image of an object as an input and using a pre-trained model that has been trained in order to output a plurality of first maps and a plurality of second maps generated from the input captured image to output the plurality of first maps and the plurality of second maps, the plurality of first maps storing a distance from a first keypoint of the object only around a second keypoint, and the plurality of second maps representing a heat map configured to have a peak at coordinates at which the keypoint of the object appears; and separating the keypoints for each object based on the plurality of first maps and the plurality of second maps that are output.

An aspect of the present invention is a computer program for causing to function as the object-specific keypoint separation apparatus.

### Effects of the Invention

According to the present invention, it is possible to reduce a memory capacity used in object-specific keypoint separation.

### BRIEF DESCRIPTION OF DRAWINGS

FIG. 1 is a block diagram illustrating a specific exemplary a functional configuration of an object-specific keypoint separation apparatus according to the present invention.

FIG. 2 is a block diagram illustrating a specific exemplary functional configuration of a training apparatus according to the present invention.

FIG. 3 is a diagram illustrating an exemplary gradient map to be trained on in an embodiment.

FIG. 4 is a flowchart showing processing of the object-specific keypoint separation apparatus according to the embodiment.

FIG. 5 is a diagram illustrating a method of calculating a vector according to the present invention.

FIG. 6 is a diagram illustrating exemplary keypoints defined in the MS COCO dataset.

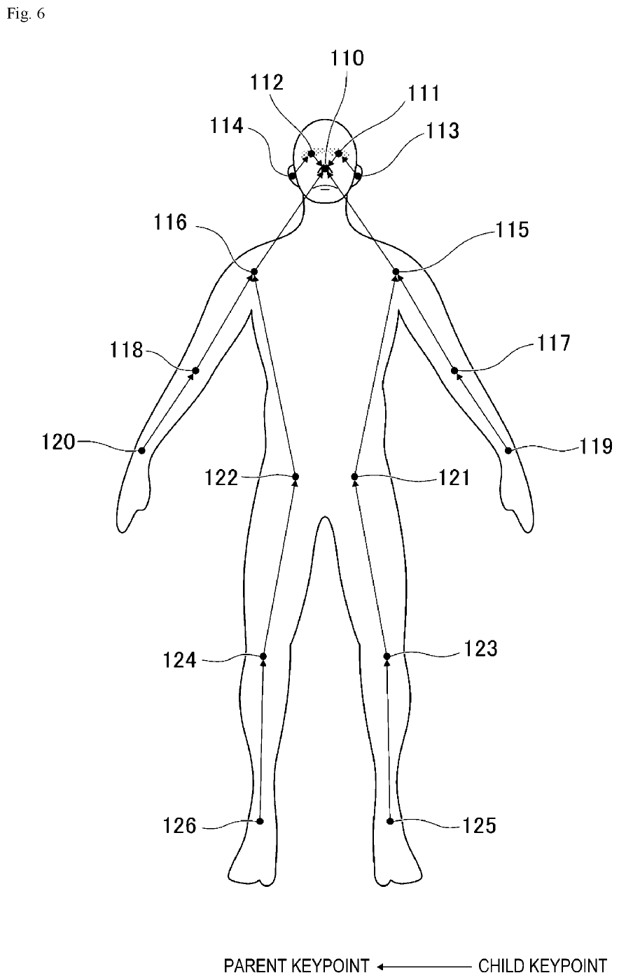

FIG. 7 is a diagram illustrating exemplary matrices of a vector field in a technique of the related art.

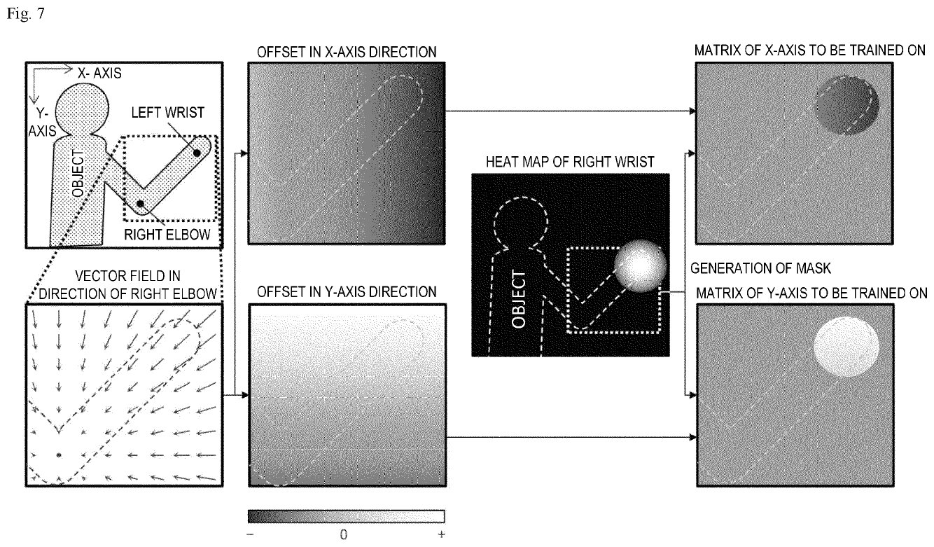

### DESCRIPTION OF EMBODIMENTS

Embodiments of the present invention will be described below with reference to the drawings.

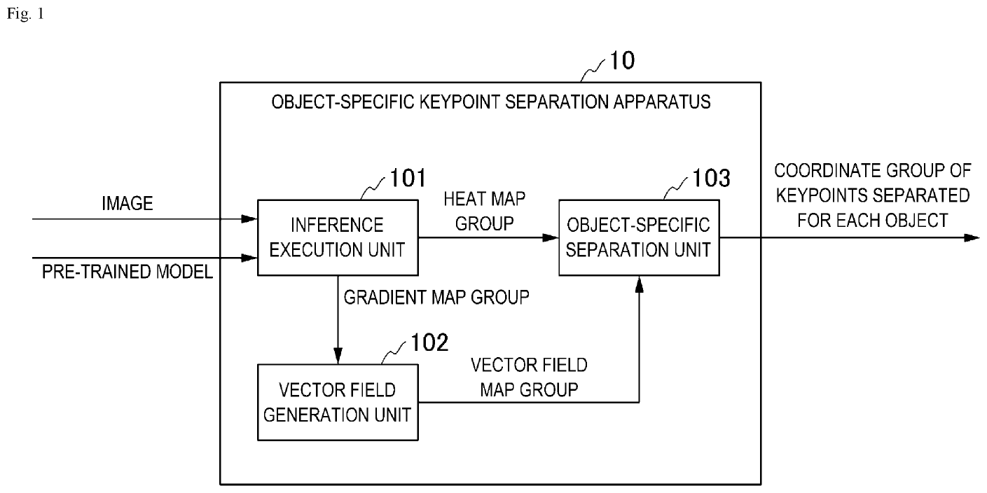

FIG. 1 is a block diagram illustrating a specific exemplary functional configuration of an object-specific keypoint separation apparatus 10 according to the present invention. The object-specific keypoint separation apparatus 10 is an apparatus that separates keypoints of objects that are persons captured in an image (hereinafter referred to as a “captured image”) for each of the objects. More specifically, the object-specific keypoint separation apparatus 10 separates the keypoints for each of the objects using the captured image and a pre-trained model generated from machine learning. A keypoint of an object in the present embodiment is a part defined for an object such as a joint, an eye, an ear, and the nose of the object.

A pre-trained model in the present embodiment is model data trained with a captured image received as an input to output a gradient map group and a heat map group. A gradient map group is a set of gradient maps (first maps) generated using a captured image and collected for all keypoints. A heat map group is a set of heat maps (second maps) generated using a captured image and collected for all keypoints. An operation using the pre-trained model will now be described. Specifically, first in a pre-trained model, gradient maps for keypoints of an object and heat maps for the keypoints are generated from an input captured image. Thereafter, in the pre-trained model, a gradient map group obtained from the generated gradient maps and a heat map group obtained from the generated heat maps are output.

Each of the gradient maps is, for example, a map having longitudinal and lateral sizes equivalent to those of a vector field, in which a distance (e.g., the number of pixels) from a first keypoint (a parent keypoint) to a keypoint of an object is saved as a value of a matrix only around a second keypoint (a child keypoint). A heat map is a map having a peak at the coordinates at which a keypoint of an object appears. The heat map is similar to a heat map used in object-specific keypoint separation of the related art. Compared to the related art that requires two matrices to describe one vector field, the present invention is characterized in that a gradient map (assumed to have longitudinal and lateral sizes equivalent to those of the vector field) is described with a single matrix. The object-specific keypoint separation apparatus 10 is configured using an information processing apparatus, for example, a personal computer.

The object-specific keypoint separation apparatus 10 includes a central processing unit (CPU), a memory, an auxiliary storage device, and the like connected to one another through a bus and executes a program. Executing the program enables the object-specific keypoint separation apparatus 10 to function as an apparatus with an inference execution unit 101, a vector field generation unit 102, and an object-specific separation unit 103. Further, all or some functions of the object-specific keypoint separation apparatus 10 may be implemented using hardware such as an application specific integrated circuit (ASIC), a programmable logic device (PLD), or a field programmable gate array (FPGA). In addition, the program may be recorded on a computer-readable recording medium. The computer-readable recording medium is, for example, a portable medium such as a flexible disk, a magneto-optical disc, a ROM, or a CD-ROM, or a storage device such as a hard disk incorporated in a computer system. In addition, the program may be transmitted and/or received via an electrical communication line.

The inference execution unit 101 uses a captured image and a pre-trained model as an input. The inference execution unit 101 uses an input captured image and the pre-trained model to output a heat map group and a gradient map group. The inference execution unit 101 outputs the heat map group to the object-specific separation unit 103, and outputs the gradient map group to the vector field generation unit 102.

The vector field generation unit 102 receives the gradient map group as an input. The vector field generation unit 102 uses the input gradient map group to generate a vector field map for each gradient map. A vector at coordinates on the gradient map can be generated by imparting a direction obtained from a gradient and a magnitude obtained from the coordinate values to a matrix value around the corresponding coordinates. The vector field generation unit 102 collects a vector field map for each of the generated gradient maps to the object-specific separation unit 103 and outputs a set of vector field maps collected for all keypoints as a vector field map group.

The object-specific separation unit 103 receives the heat map group and the vector field map group as an input. The object-specific separation unit 103 uses the input heat maps and vector field maps for each keypoint to separate the keypoints for each object. The object-specific separation unit 103 separates the keypoints in a tree-shaped hierarchical structure for each object and outputs a coordinate group indicating the separation result (a coordinate group of the keypoints separated for each object) to the outside.

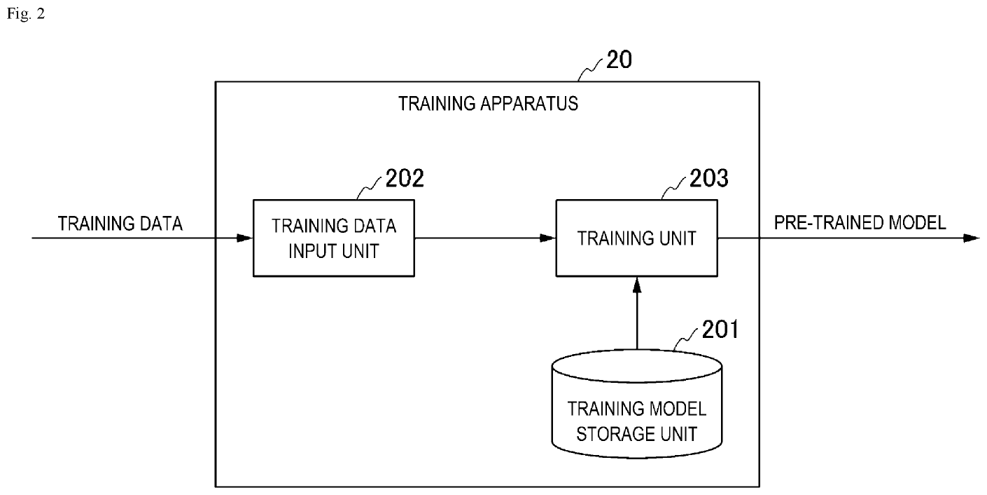

FIG. 2 is a block diagram illustrating a specific exemplary functional configuration of a training apparatus 20 according to the present invention. The training apparatus 20 is an apparatus that generates a pre-trained model to be used by the object-specific keypoint separation apparatus 10. The training apparatus 20 is communicably connected to the object-specific keypoint separation apparatus 10. The training apparatus 20 includes a CPU, a memory, an auxiliary storage device, and the like connected to one another through a bus and executes a program. Executing the program enables the training apparatus 20 to function as an apparatus including a training model storage unit 201, a training data input unit 202, and a training unit 203. Further, all or some functions of the training apparatus 20 may be realized using hardware such as an ASIC, a PLD, or an FPGA. In addition, the program may be recorded on a computer-readable recording medium. The computer-readable recording medium is, for example, a portable medium such as a flexible disk, a magneto-optical disc, a ROM, or a CD-ROM, or a storage device such as a hard disk incorporated in a computer system. In addition, the program may be transmitted and/or received via an electrical communication line.

The training model storage unit 201 is configured using a storage device such as a magnetic storage device or a semiconductor storage device. The training model storage unit 201 stores a training model for machine learning in advance. Here, the training model is information representing a machine learning algorithm used to train a relationship between input data and output data. Although there are various learning algorithms for supervised learning including various regression analysis methods, a decision tree, a k-nearest neighbor method, a neural network, a support vector machine, deep learning, and the like, a case in which deep learning is used will be described in the present embodiment. Further, for the learning algorithm, another training model described above may be used.

The training data input unit 202 has a function of randomly selecting samples from a plurality of pieces of input training data and outputting the selected samples to the training unit 203. The training data is data for learning used in supervised learning and is data represented by a combination of input data and output data that is assumed to be correlated with the input data. Here, the input data is a captured image, and the output data is a heat map group and a gradient map group paired with the captured image.

The training data input unit 202 is communicably connected to an external apparatus (not illustrated) storing a training data group and receives the training data group as an input from the external apparatus via the communication interface of the apparatus. In addition, for example, the training data input unit 202 may be configured to receive the training data group as an input by reading the training data group from a recording medium (for example, a universal serial bus (USB) memory, a hard disk, or the like) storing the training data group in advance.

The training unit 203 generates a pre-trained model by performing training so as to minimize a difference between a first set of a heat map group and a gradient map group obtained by converting the captured image of the sample of the training data output from the training data input unit 202 using the training model and a second set of a heat map group and a gradient map group in the training data. The generated pre-trained model is input to the object-specific keypoint separation apparatus 10. Further, the input of the pre-trained model to the object-specific keypoint separation apparatus 10 may be performed through communication between the object-specific keypoint separation apparatus 10 and the training apparatus 20, or may be performed using a recording medium on which the pre-trained model has been recorded.

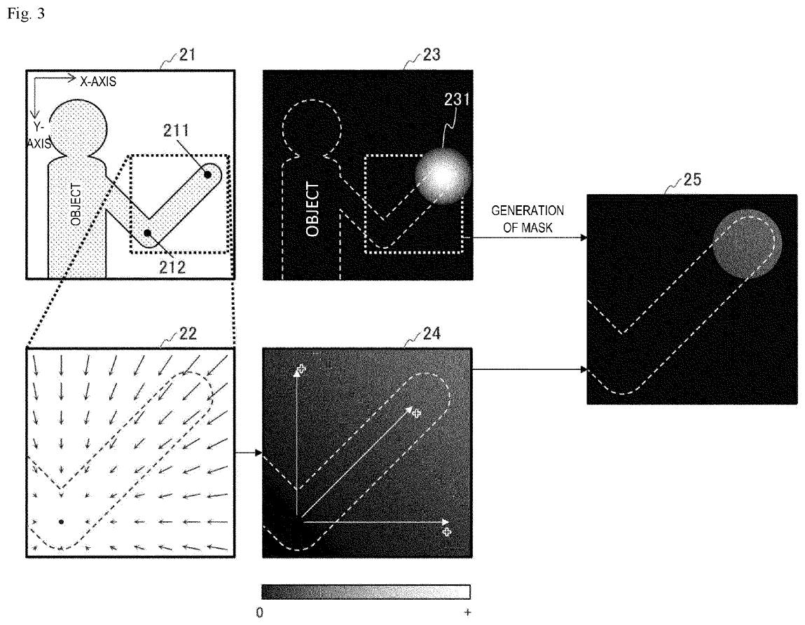

FIG. 3 is a diagram illustrating an exemplary gradient map to be trained on in an embodiment. The image 21 illustrated in FIG. 3 is a captured image of an object. The keypoint 211 of the object shown in the image 21 indicates “right wrist”, and the keypoint 212 indicates the right elbow. Here, it is assumed that the right wrist is a child keypoint and the right elbow is a parent keypoint. In this case, a vector field in the direction to the parent keypoint 212 (right elbow) from the child keypoint 211 (right wrist) is seen as in the image 22.

The image 23 in FIG. 3 represents a heat map of 211 (right wrist), and the image 24 represents a gradient map showing a distance from the keypoint 212 (right elbow). The image 25 is generated by combining a mask image generated based on the region 231 of the heat map of the image 23 with the gradient map of the image 24. This image 25 is a gradient map to be trained on by the training unit 203. The gradient map saves the distance (the number of pixels) from the correct coordinate values of the parent keypoint as a matrix value, as illustrated in FIG. 3. For example, in the case of a gradient map describing a direction of a parent keypoint viewed from a child keypoint, the gradient map is trained on such that a radial concentric gradation is formed around the correct coordinates of the parent keypoint and only matrix values around the child keypoint are left so that other matrix values are set to zero.

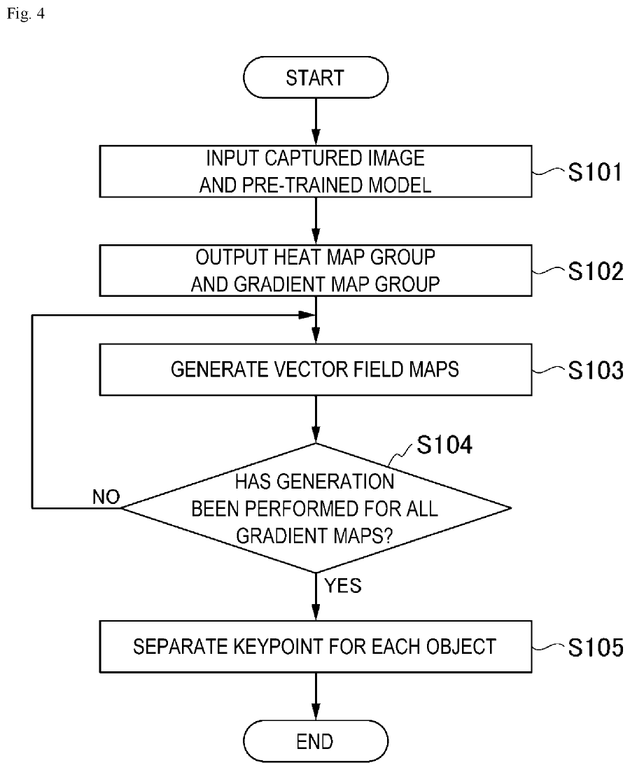

FIG. 4 is a flowchart showing the processing of the object-specific keypoint separation apparatus 10 according to the embodiment.

The inference execution unit 101 receives a captured image and a pre-trained model from the outside as an input (step S101). The captured image and the pre-trained model do not need to be input at the same timing. In a case in which the inference execution unit 101 has already acquired the pre-trained model from the training apparatus 20 before starting the processing of FIG. 4, the inference execution unit 101 receives only the captured image as an input in the processing of step S101.

Inputting the captured image into the pre-trained model that has been input causes the inference execution unit 101 to output a heat map group and a gradient map group of the object captured in the captured image (step S102). The inference execution unit 101 outputs the heat map group to the object-specific separation unit 103. The inference execution unit 101 outputs the gradient map group to the vector field generation unit 102.

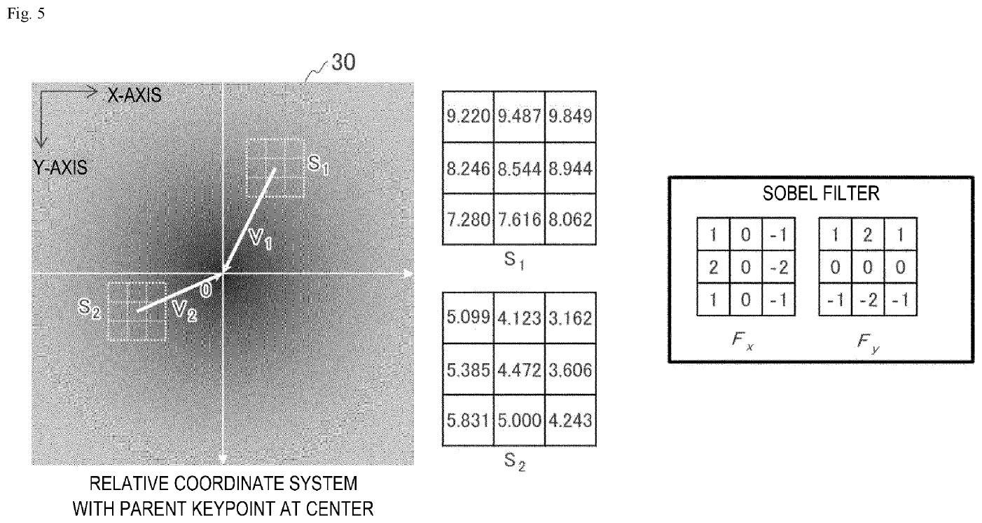

The vector field generation unit 102 generates a vector field map group from the gradient map group output from the inference execution unit 101 (step S103). For example, to describe using FIG. 5, the vector field generation unit 102 calculates the distance from the coordinate values of the center of the parent keypoint for the vectors (V₁ and V₂ in FIG. 5) calculated in the process of step S103, and calculates directions from axial gradient intensities dx and dy obtained by applying a Sobel filter (Fₓ and F_{y}) to values in 3×3 blocks (S₁ and S₂ in FIG. 5) around the coordinate values of the parent keypoint on the gradient map 30 in the longitudinal and lateral directions using equations (1) and (2). Further, although the 3×3 blocks around the coordinate values of the parent keypoint are applied in the present embodiment, this is an example, and a size of a block is not limited to a particular size.

$$\begin{matrix}[ Math . 1 ] & \\ {G}_{1} = ( \begin{matrix}{F}_{x} ( {S}_{1} ) \\ {F}_{y} ( {S}_{1} )\end{matrix} ) = ( \begin{matrix}- 2.807582521 \\ 7.468154371\end{matrix} ) & ( 1 )\end{matrix}$$

$${V}_{1} = \frac{8.544 {G}_{1}}{{‖ {G}_{1} ‖}_{2}} = ( \begin{matrix}- 3.006594105 \\ 7.99752411\end{matrix} )$$

$$\begin{matrix}[ Math . 2 ] & \\ {G}_{2} = ( \begin{matrix}{F}_{x} ( {S}_{2} ) \\ {F}_{y} ( {S}_{2} )\end{matrix} ) = ( \begin{matrix}- 2.807582521 \\ 7.468154371\end{matrix} ) & ( 2 )\end{matrix}$$

$${V}_{2} = \frac{4.472 {G}_{2}}{{‖ {G}_{2} ‖}_{2}} = ( \begin{matrix}3.994584913 \\ - 2.010793718\end{matrix} )$$

FIG. 5 is a diagram for describing a method of calculating a vector according to the present invention. Further, if the vector field generation unit 102 generates a vector with reference to only one point, superimposed noise may have an impact during execution of inference in machine learning. For this reason, the vector field generation unit 102 may use values around the coordinate values of a parent keypoint to determine a plurality of vectors, and use the average value to increase accuracy.

The vector field generation unit 102 determines whether a vector field map has been generated for all gradient maps (gradient map group) (step S104). If a vector field map is not generated for all gradient maps (No in step S104), the processing of step S103 is repeated. Specifically, the vector field generation unit 102 generates a vector field map using a gradient map for which no vector field map has been generated. If a vector field map is generated for all gradient maps (Yes in step S104), the vector field generation unit 102 outputs the generated vector field map group to the object-specific separation unit 103.

The object-specific separation unit 103 uses the heat map groups output from the inference execution unit 101 and the vector field map group output from the vector field generation unit 102 to separate keypoints for each object (step S105). The object-specific separation unit 103 outputs a coordinate group of the keypoints separated for each object.

According to the object-specific keypoint separation apparatus 10 configured as described above, it is possible to reduce a memory capacity used in object-specific keypoint separation. Specifically, the object-specific keypoint separation apparatus 10 uses a captured image as an input and acquires a gradient map group and a heat map group of an object by inputting the captured image into the pre-trained model. Then, the object-specific keypoint separation apparatus 10 separates the keypoints for each object based on the acquired gradient map group and heat map group. While the inference execution unit of a general object-specific keypoint separation apparatus in the related art directly outputs a vector field group, the object-specific keypoint separation apparatus 10 of the present invention outputs a gradient map group. That is, although a total of two matrices of a matrix representing values in the x-axis direction and a matrix representing values in the y-axis direction for coordinates of a vector field are used in the related art, the object-specific keypoint separation apparatus 10 uses gradient maps, which allows a single matrix to describe the two matrices required to calculate one vector field. As a result, it is possible to reduce a memory capacity used in object-specific keypoint separation.

The object-specific keypoint separation apparatus 10 includes the vector field generation unit 102 that generates a vector field map for each gradient map using a gradient map group output from the inference execution unit 101 and the object-specific separation unit 103 that separates keypoints for each object by combining a heat map group output from the inference execution unit 101 with the vector field map group generated by the vector field generation unit 102. As a result, the object-specific keypoint separation apparatus 10 can be introduced without changing the processing of the object-specific separation unit 103 with the vector field generation unit 102 converting the output of the inference execution unit of the general object-specific keypoint separation apparatus of the related art. Thus, the object-specific keypoint separation apparatus 10 according to the present invention can be obtained simply by changing a part of a general object-specific keypoint separation apparatus.

The gradient map used in the present embodiment is a map in which the number of pixels from the coordinate values of a parent keypoint to the coordinate value of a child keypoint is represented by a value of a matrix. Thus, two matrices required to calculate one vector field can be described in a single matrix. As a result, it is possible to reduce a memory capacity used in object-specific keypoint separation.

### Modified Example

The object-specific keypoint separation apparatus 10 and the training apparatus 20 may be configured to be integrated. Specifically, the object-specific keypoint separation apparatus 10 may be configured to have the learning function of the training apparatus 20. With this configuration, the object-specific keypoint separation apparatus 10 has a learning mode and an inference mode, and performs operations corresponding to each of the modes. Specifically, in the learning mode, the object-specific keypoint separation apparatus 10 generates a pre-trained model by performing the same processing as that performed by the training apparatus 20. In the inference mode, the object-specific keypoint separation apparatus 10 executes the processing shown in FIG. 4 using the generated pre-trained model.

The vector field generation unit 102 and the object-specific separation unit 103 may be implemented in one functional unit. In this case, the object-specific keypoint separation apparatus 10 includes the inference execution unit 101 and an object-specific keypoint separation unit. The object-specific keypoint separation unit includes the functions of the vector field generation unit 102 and the object-specific separation unit 103. In other words, the object-specific keypoint separation unit uses a gradient map group output from the inference execution unit 101 to generate a vector field map for each gradient map. Furthermore, the object-specific keypoint separation unit uses the generated vector field map group and the heat map group output from the inference execution unit 101 to output a coordinate group of keypoints separated for each object.

In the above-described embodiment, the vector field generation unit 102 is introduced with the configuration that generates a vector field map for each gradient map. However, the object-specific separation unit 103 may be configured such that the input of a vector field group is replaced with a gradient map group and vectors are generated each time as necessary in the internal processing of the object-specific separation unit 103, without the vector field generation unit 102 generating a vector field map group in advance.

Although embodiments of the present invention have been described above in detail with reference to the drawings, a specific configuration is not limited to the embodiments, and designs that do not depart from the gist of the present invention are also included.

### INDUSTRIAL APPLICABILITY

The present invention can be applied to a technology to separate keypoints of objects detected from an image capturing the objects for each object.

### REFERENCE SIGNS LIST

10 Object-specific keypoint separation apparatus
20 Training apparatus
101 Inference execution unit
102 Vector field generation unit
103 Object-specific separation unit
201 Training model storage unit
202 Training data input unit
203 Training unit

1. An object-specific keypoint separation apparatus comprising:
a processor; and
a storage medium having computer program instructions stored thereon, when executed by the processor, perform to:
receive a captured image capturing an object as an input and use a pre-trained model that has been trained in order to output a plurality of first maps and a plurality of second maps generated from the input captured image to output the plurality of first maps and the plurality of second maps, the plurality of first maps storing a distance from a first keypoint of the object only around a second keypoint, and the plurality of second maps representing a heat map configured to have a peak at coordinates at which the keypoint of the object appears; and
separate the keypoints for each object based on the plurality of first maps and the plurality of second maps output from the inference execution unit.

2. The object-specific keypoint separation apparatus, according to claim 1, wherein the computer program instructions further perform to use the plurality of first maps to generate a plurality of vector fields for the plurality of first maps, and
keypoints for each of the objects by combining the plurality of second maps output from the inference execution unit with the plurality of vector fields.

3. The object-specific keypoint separation apparatus according to claim 1,
wherein the inference execution unit outputs, as the plurality of first maps, maps on which the number of pixels indicating the distance from the first keypoint is represented by a value of a matrix only around the second keypoint.

4. The object-specific keypoint separation apparatus according to claim 2, wherein the computer program instructions further perform to calculates a size of a distance from a coordinate value of the first keypoint for the plurality of first maps and calculates gradient intensities for a longitudinal axis and a lateral axis by applying a predetermined filter with the same size as a predetermined block to a coordinate value of the predetermined block around the coordinates of the first keypoint to generate a plurality of vector fields.

5. An object-specific keypoint separation method comprising:
receiving a captured image of an object as an input and using a pre-trained model that has been trained in order to output a plurality of first maps and a plurality of second maps generated from the input captured image to output the plurality of first maps and the plurality of second maps, the plurality of first maps storing a distance from a first keypoint of the object only around a second keypoint, and the plurality of second maps representing a heat map configured to have a peak at coordinates at which the keypoint of the object appears; and
separating the keypoints for each object based on the plurality of first maps and the plurality of second maps that are output.

6. A non-transitory computer-readable medium having computer-executable instructions that, upon execution of the instructions by a processor of a computer, cause the computer to function as the object-specific keypoint separation apparatus according to claim 1.
